(19) United States
(12) Patent Application Publication
(10) Pub. No.: US 2021/0063251 A1
(43) Pub. Date: Mar. 4, 2021

(54) TEMPERATURE MONITORING DEVICE AND DISPENSER THEREFOR

(71) Applicant: M V G Electrical Pty Ltd, Queensland (AU)

(72) Inventor: Mark Gleadhill, Main Beach Queensland (AU)

(73) Assignee: M V G Electrical Pty Ltd, Queensland (AU)

(21) Appl. No.: 16/555,754

(22) Filed: Aug. 29, 2019

(51) Int. Cl. G01K 11/12; G08B 5/00; B65D 83/04

(52) U.S. Cl. CPC G01K 11/12; G01K 13/08; B65D 83/0418; G08B 5/00

(57) ABSTRACT

A temperature monitoring device provides an operator a visual indication of the temperature of a machine component reaching a predetermined threshold temperature. The device includes at least one region of thermochromic material which changes from an initial color to an activated color when the machine component reaches a threshold temperature.

### TECHNICAL FIELD

The present invention generally relates to a temperature monitoring device and to a method for monitoring temperature, such as but not limited to the monitoring of temperatures of conveyor components. The present invention also relates to a dispenser for dispensing a plurality of devices.

### BACKGROUND OF THE INVENTION

One of the most common sources of heating and potential ignition source in underground coal mines is the frictional overheating of conveyor idlers internal bearings that are in the process of or have failed in service. Control measures that are risk ranked manage this identified hazard, yet continually fail.

The primary control used to manage this potential ignition source is regular monitoring. This takes place in the form of suitably qualified competent coal mine workers, maintenance personal and Statutory Officials carrying out periodic visual inspections along the conveyance system, ensuring varying levels of site and legislative compliance is maintained.

When managing risks for both the health and safety associated with the operation of conveyor belts in a mine, one of the foremost considerations is given to the competent inspection of the system, to detect and act on any overheating, smouldering or any other condition likely to cause fire. To add further guidance, it is also legislated in some jurisdictions that maximum allowable surface temperatures in an underground coal mine is 150° C.

Therefore, in the above and many other situations, it is desirable to have a means of visually determining the temperature of components without the use of expensive and/or complicated monitoring equipment.

The reference in this specification to any prior publication (or information derived from it), or to any matter which is known, is not, and should not be taken as, an acknowledgement or admission or any form of suggestion that prior publication (or information derived from it) or known matter forms part of the common general knowledge in the field of endeavour to which this specification relates.

### SUMMARY OF THE INVENTION

According to one example aspect of the invention, there is provided a device for detecting the temperature of an item, including a first region that changes from a first initial colour to a first activated colour when above a first temperature.

In one form, the device further includes a second region separate from the first region, wherein the second region changes from a second initial colour to a second activated colour when above a second temperature. Preferably, the second temperature is higher than the first temperature.

Preferably, the first activated colour is different to the second activated colour. In one example form, the first activated colour is yellow or orange and the second activated colour is red.

In one form, the first temperature is between about 50° C. and about 70° C., and preferably about 60° C. In another form, the second temperature is between about 90° C. and about 110° C., and preferably about 100° C.

In still further particular, but non-limiting, example forms: the first region remains at the first activated colour when the temperature returns from above the first temperature to below the first temperature; and the second region remains at the second activated colour when the temperature returns from above the second temperature to below the second temperature.

In accordance with another optional embodiment, provided by way of example only, the device is in the form of a disk that can be removably attached to a surface. In one form, the device includes a magnetic portion to enable attaching to a metallic surface. Preferably, the item is a roller of a conveyor.

According to another example aspect, there is provided an apparatus for dispensing a plurality of devices, wherein the devices are substantially as defined herein, the apparatus including a tube with an end cap, the end cap having an opening partially obscured by a flange, such that a device can only be removed in a lateral direction relative to a longitudinal axis of the tube.

According to yet another example aspect, there is provided a method of applying a device, wherein the device is substantially as defined herein. In one form, the method uses the apparatus that is substantially as defined herein to apply the device. Preferably, the devices are applied to the roller of a conveyor.

In one broad form, the present invention provides a temperature monitoring device for providing a visual indication of the temperature of a machine component reaching a predetermined threshold temperature, wherein said device includes at least one region of thermochromic material which changes from an initial colour to an activated colour when said machine component reaches said threshold temperature.

Preferably, said device includes first and second regions of thermochromic material, wherein said first region of thermochromic material provides a visual indication of said machine component reaching a first threshold temperature, and said second region of thermochromic material provides a visual indication of machine component reaching a second threshold temperature.

Also preferably, the device includes:
a first side adapted to be attached to said machine component; and,
a second side including the at least one region of thermochromic material.

Preferably, said first side of said device is adapted to be removably attached to said machine component.

Also preferably, said first side of said device is at least partly formed of magnetic material, such that, said device is adapted to be magnetically attached to a metallic surface of said machine component.

Preferably, wherein said device is embodied as a disc which is removably magnetically attachable to said machine component.

Preferably, said device is attached to said machine component using a dispensing apparatus which is adapted to dispense a plurality of said temperature monitoring devices.

In an alternatively preferred form, said device is integrally formed as part of said machine component.

In a preferred embodiment said machine component is a roller of a conveyor.

In a further broad form, the present invention provides a dispensing apparatus, which is adapted to house a plurality of the temperature monitoring devices as hereinbefore described, the apparatus including a tube with an end cap, the end cap, wherein the tube is adapted to house a plurality of disc-shaped devices, the end cap having an opening partially obscured by a flange, whereby, each device may be removed from the dispensing apparatus in a lateral direction relative to a longitudinal axis of the tube.

In a further broad form, the present invention provides a dispenser including:
a tube adapted to house a plurality of devices;
biasing means associated with said tube adapted to bias any devices within said tube towards a dispensing end of said tube; and,
the dispensing end including an opening with a flange partially surrounding said opening;
such that in use, when the dispenser is moved in a lateral direction, one of said devices housed within said tube is dispensed from said tube.

### BRIEF DESCRIPTION OF FIGURES

Example embodiments should become apparent from the following description, which is given by way of example only, of at least one preferred but non-limiting embodiment, described in connection with the accompanying figures, wherein:

FIG. 1A illustrates a front perspective view of a device according to one embodiment of the invention;

FIG. 1B illustrates a black line version of the same front perspective view of the device from FIG. 1;

FIG. 1C illustrates FIG. 1B with hidden lines shown;

FIG. 2A illustrates a rear perspective view of the device from FIG. 1;

FIG. 2B illustrates FIG. 2A with hidden lines shown;

FIG. 3 illustrates a rear view of the device from FIG. 1;

FIG. 4 illustrates a front view of the device from FIG. 1;

FIG. 5 illustrates a side view of the device from FIG. 1;

FIG. 6 illustrates an enlarged perspective view of the end of a dispenser;

FIG. 7 illustrates a perspective view of the dispenser from FIG. 6;

FIG. 8 illustrates a side view of the dispenser from FIG. 6;

FIG. 9 illustrates a perspective view of the dispenser from FIG. 6 with the spring removed and placed beside the dispenser;

FIG. 10 illustrates a top isometric view of the dispenser cap that forms part of the dispenser from FIG. 6;

FIG. 11 illustrates a bottom isometric view of the dispenser cap from FIG. 10;

FIG. 12 illustrates a side view of the dispenser cap from FIG. 10;

FIG. 13 illustrates a front view of the dispenser cap from FIG. 10;

FIG. 14 illustrates a top view of the dispenser cap from FIG. 10; and

FIG. 15 illustrates a bottom view of the dispenser cap from FIG. 10.

### DETAILED DESCRIPTION OF PREFERRED EMBODIMENTS

The following modes, given by way of example only, are described in order to provide a more precise understanding of the subject matter of a preferred embodiment or embodiments.

In the Figures, incorporated to illustrate features of an example embodiment, like reference numerals are used to identify like parts throughout the Figures.

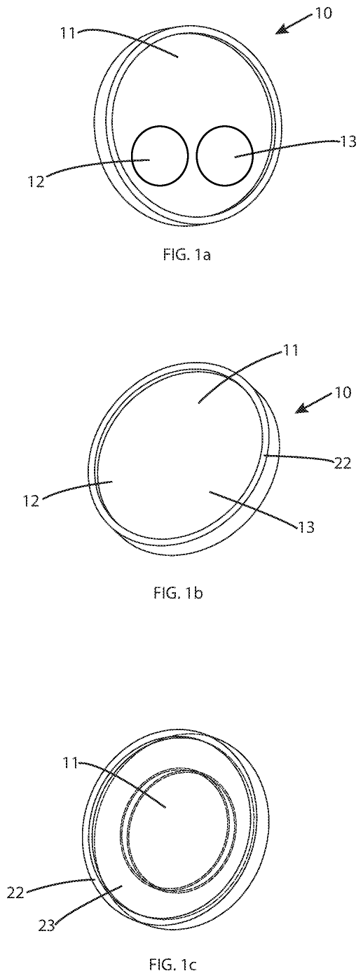

Referring to FIG. 1, a device 10 is shown that can be used for detecting the temperature of an item, or more specifically for detecting when certain temperatures have been exceeded. The device 10 includes a front side 11 that has a first region 12 and a second region 13.

The second region 13 is separate from the first region 12, allowing the two regions to be clearly distinguished. It will be appreciated, however, that alternative arrangements of the regions 12, 13 may be possible and they could be adjacent and adjoining one another in some embodiments.

The first region 12 and the second region 13 have corresponding initial colours, which in the preferred embodiment is white for both the first 12 and second 13 region. When the temperature of the device 10 is raised above a first temperature, the first region 12 changes from the first initial colour to a first activated colour. The change in colour of the first region 12 allows simple identification that the device 10 has been raised past this first threshold temperature.

Similarly, when the temperature of the device 10 is raised above a second temperature, the second region 13 changes from the second initial colour to a second activated colour. The change in colour of the second region 13 allows simple identification that the device 10 has been raised past this second threshold temperature.

In the preferred embodiment, the second temperature is higher than the first temperature. This allows the first region 12 to be used as an initial warning level, and the second region 13 to be used as a more serious warning, such as a warning that immediate attention is required, for example.

It will be appreciated that alternative embodiments of the invention could use only one region, but also that still other embodiments could use three or more regions. In such a case, all regions may have different threshold temperatures, allowing a more detailed, gradual indication of the temperature that has been reached.

In the preferred embodiment, the first activated colour is different to the second activated colour. More specifically, the first activated colour is yellow or orange, while the second activated colour is red. Further, the activated colours are not a single, solid block of colour, but instead also include some text. In this case, the text identifies the specific threshold temperature that has been exceeded.

For the device 10 shown, the first temperature is between about 50° C. and about 70° C., but most preferably about 60° C. The second temperature is between about 90° C. and about 110° C., but most preferably about 100° C.

The first region remains at the first activated colour when the temperature returns from above the first temperature to below the first temperature. The second region also remains at the second activated colour when the temperature returns from above the second temperature to below the second temperature. This allows the device 10 to indicate that it has been above one or both of the threshold temperatures, even if it is no longer at the elevated temperature when it is viewed.

It will be appreciated, however, that alternative embodiments could be made where the colour returns to the original colour when the temperature lowers, for situations where such a device may be more useful or appropriate.

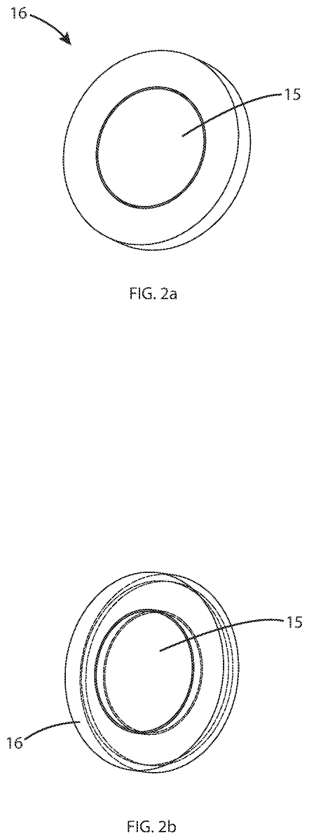

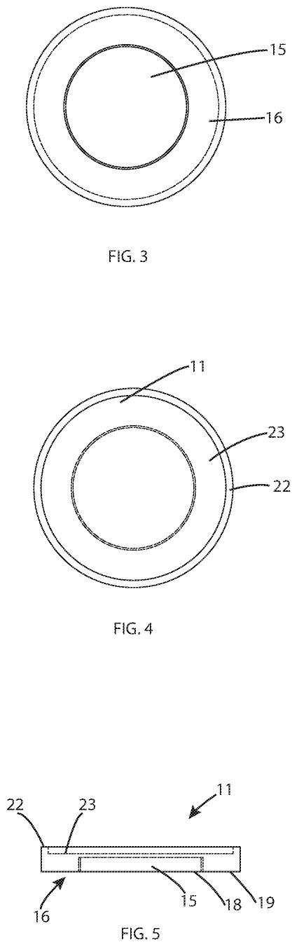

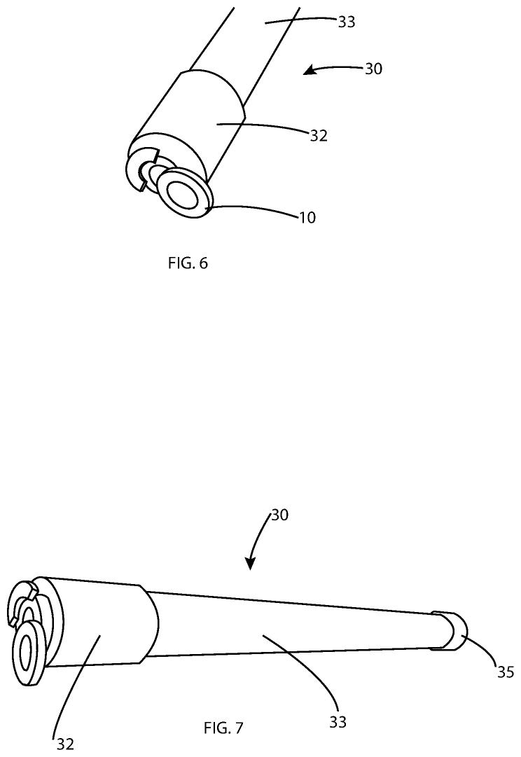

Referring now to FIGS. 2 and 3, the device 10 includes a magnet 15 on a rear side 16 of the device 10. As shown more clearly in FIG. 5, the magnet 15 is inlaid in the rear side 16, such that the outer surface 18 of the magnet 15 is flush with, or aligned with, the rear surface 19.

The device 10 is in the form of a disk that can be removably attached to a surface. Attachment to metallic surfaces is particularly advantageous, with the magnet 15 being a simple method of holding the device 10 in place.

When attached to a surface, such as part of a conveyance system, for example, heat from the surface is conducted directly to the device 10, raising or lowering the temperature of the entire device 10 with the surface.

The front side 11 of the device 10 includes a rim 22 around the periphery extending outwardly relative to a surface 23 on which the first region 12 and second region 13 are located. This recessed nature of the front surface 23 is shown most clearly in FIG. 5. Such a configuration is advantageous for preventing damage to the surface 23.

The preferred embodiment of the device 10 is made from stainless steel, with a NdFeB Neodymium NiCuNi coated magnet 15. The magnet 15 is arranged with axial N and S poles, so that there is no magnetisation of the front face 11 or the area of the rear side 16 surrounding the magnet 15. This prevents stray ferromagnetic material, such as steel filings, from accumulating on and around the device 10 when in use. This helps to ensure the first region 12 and the second region 13 are always clearly visible, for example.

The first region 12 and the second region 13 have a metallised polyethylene (PET) film with a transparent PET environmental cover seal. These regions 12, 13 also include a thermochromic dye that undergoes an irreversible colour change to opaque at the set temperatures described previously. Such materials and other alternative materials are known in the art for producing the required colour changes as described previously.

The device 10, in one example application, is intended as a single use disposable operator or inspector first warning indicator system, to assist in the early detection of mechanical components succumbing to frictional heating in a mining environment, because of component failure on a bulk materials handling conveyance system.

With visual inspections being a major recognised control for the detection of overheating, smouldering and fires in the mining workplace, the device 10 can assist those undertaking the inspections, discharge their obligations and duties effectively, by recognising an elevated hazard before becoming an unacceptable risk.

The concept of the device 10 is easily adapted and added to a mine's Safety Health Management System as part of inspection plans, management/hazard/control plans, critical control monitoring activities, mechanical engineering control plans and other critical risk management documents.

The concept of the device 10 is to give the operation a simple, affordable, functional and effective resource in which to empower the persons completing inspections and maintenance on conveyor belts, to be able to make sound and practical decisions, based on a visual repeatable engineered solution.

The majority of “hot rollers” detected during inspections is either from noise or smell. At the advanced stages of failure, visual signs of a reddish oxidised powder on the roller shaft and or immediate structure (+200° C.) can be seen. Smoke and or fire are also likely and not uncommon. It is widely accepted that people carrying out inspections should be aware of the role one's senses play in discovering fires.

The device 10 gives first visual indications of a failing bearing prior to the oxidisation, smoke or fire. The first visual indication is at ≥60° C. and second final warning at ≥100° C. The device's predict and prevent approach allows for a proactive resilient inspection scheme, over a reactive inspection structure allowing non-compliances to legislative obligations.

Example applications of the device 10 in relation to the conveyors include idlers, rollers, pulleys, anti-runbacks, gearboxes, electric motors and the structure.

The device 10 is advantageous as it allows the prediction and early detection of deteriorating idler bearings, and aids in greatly improving the reliability and availability of the conveyance system by: allowing the replacement of the idler pre-failure in a scheduled manner; allowing informed decisions based on a repeatable engineered solution; allowing decisions to “run to maintenance” or “drop the idler out” based on a visual tell tail; allowing maintenance personal and idler change out crews target the correct idlers with greater confidence on maintenance days, adding to the efficiency and effectiveness of the maintenance strategy, converting into operational uptime; allowing for informed planning of resources during maintenance periods; reduce the opportunity for the idlers to have a damaging influence on the conveyor belting; reduce the opportunity for the idlers to enter a state of being a potential ignition source; and mining workers confidence in the process and systems keeping them safe.

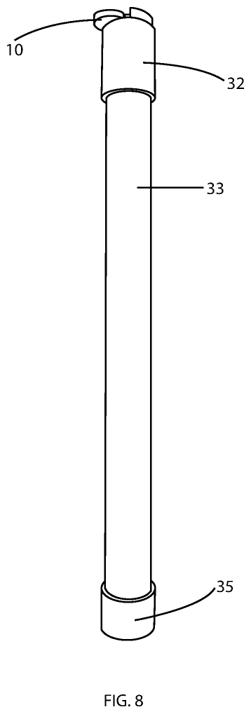

Referring now to FIGS. 6 to 9, a dispenser 30 is shown that can be used to hold and dispense a plurality of the devices 10 described previously. The dispenser 30 includes a dispenser cap 32 fitted to the end of a tube 33. The end of the tube 33 opposite the dispenser cap 32 is closed by an end cap 35.

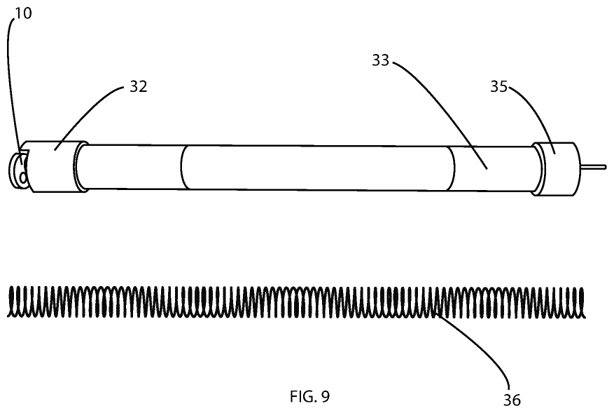

The inside diameter of the tube 33 is slightly larger than the diameter of the device 10, such that the tube can be filled with a stack of devices 10. A spring 36 (shown removed from the dispenser 30 in FIG. 9) is positioned between the stack of devices 10 and the end cap 35, so that as devices 10 are removed from the dispenser cap 32, the remaining devices 10 are forced towards the dispenser cap 32.

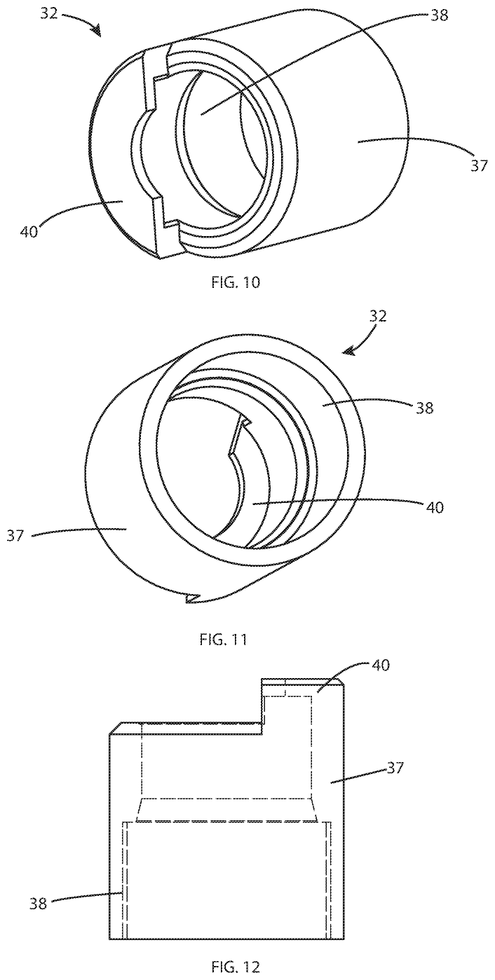

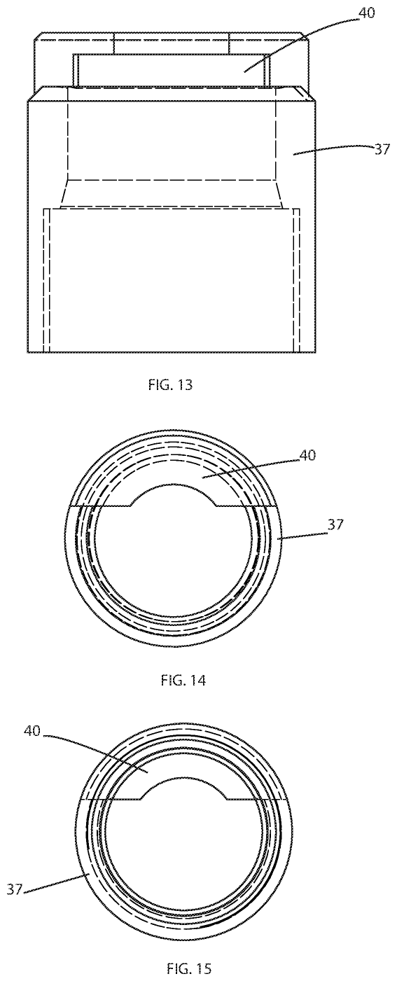

Referring now to FIGS. 10 to 15, the dispenser cap 32 includes a side wall 37 with an interior thread 38 for connecting to the tube 33. A raised flange 40 extends from an end of the dispenser cap 32 and across to partially cover the opening, as shown in FIGS. 14 and 15, for example.

The flange 40 stops the devices 10 flowing out the end of the tube 33 in an axial direction. Instead, a single device 10 can be removed in a lateral direction, with the following device then being forced up by the spring to abut the flange 40. In this way, single devices 10 can be easily removed one at a time as required.

It will be appreciated that the dispenser is advantageous as it avoids the need for a user to have to place their hands on or near a conveyor roller, which could be extremely hot and also otherwise dangerous due to the various moving parts of conveyor systems.

The devices 10 can be supplied packaged in the dispenser, which may be a 100 bulk disk dispenser or a 12 everyday disk dispenser, for example. Such packaging allows for ease of transportation and application. The devices 10 can be applied with a tap and slide method, direct from the dispenser 30 to an idler shaft end, for example, or dispensed individually into a user's hand for placement as preferred.

The devices 10 are a powerful unidirectional potted Neodymium copper/nickel coated rare earth magnet, which ensures a positive connection to a clean uniform ferromagnetic surface. This allows for the effective transfer of heat energy to the thermochromic heat indication label completing the device 10.

In one example application, the devices 10 are intended to be mounted on the shaft end of the conveyor idler. In such a situation, a lag period exists between the core temperature of the failing bearing that is in communication with the shaft, to the device 10 located on the end of the shaft.

Once the increasing temperature has been transferred to the device 10, the thermochromic white dots will become translucent at the prescribed temperatures of ≥60° C. as first warning of an elevated condition and ≥100° C. for final warning of a deteriorated condition revealing the orange and red temperature emblazoned spots beneath.

Preferably, the device 10 has an accuracy of ±5° C., however in some situations an accuracy of ±10° C. may be considered acceptable.

With the average operating temperature of a healthy conveyor idler in the hotter regions of underground mining ranging from 25° C. to 35° C., the first activation at ≥60° C. gives an adequate tolerance in operational conditions and load variations, to determine that the idler/roller bearing is in fact in a deteriorating state.

In the foregoing description of preferred embodiments, specific terminology has been resorted to for the sake of clarity. However, the invention is not intended to be limited to the specific terms so selected, and it is to be understood that each specific term includes all technical equivalents which operate in a similar manner to accomplish a similar technical purpose. Terms such as “front” and “rear”, “inner” and “outer”, “above” and “below” and the like are used as words of convenience to provide reference points and are not to be construed as limiting terms.

Whilst the present invention has been described with reference to particular embodiments, it will be understood that many modifications will be apparent to those skilled in the art. All such variations and modifications should be considered to fall within the scope of the invention as broadly described and as claimed below.

Throughout this specification and the claims which follow, unless the context requires otherwise, the word “comprise”, and variations such as “comprises” or “comprising”, will be understood to imply the inclusion of a stated integer or step or group of integers or steps but not the exclusion of any other integer or step or group of integers or steps.

1. A temperature monitoring device for providing a visual indication of the temperature of a machine component reaching a predetermined threshold temperature, wherein said device includes at least one region of thermochromic material which changes from an initial colour to an activated colour when said machine component reaches said threshold temperature.

2. The temperature monitoring device as claimed in claim 1, wherein said device includes first and second regions of thermochromic material, wherein said first region of thermochromic material provides a visual indication of said machine component reaching a first threshold temperature, and said second region of thermochromic material provides a visual indication of machine component reaching a second threshold temperature.

3. The temperature monitoring device as claimed in claim 1, including:
a first side adapted to be attached to said machine component; and,
a second side including the at least one region of thermochromic material.

4. The temperature monitoring device as claimed in claim 3, wherein said first side of said device is adapted to be removably attached to said machine component.

5. The temperature monitoring device as claimed in claim 3, wherein said first side of said device is at least partly formed of magnetic material, such that, said device is adapted to be magnetically attached to a metallic surface of said machine component.

6. The temperature monitoring device as claimed in claim 1, wherein said device is embodied as a disc which is removably magnetically attachable to said machine component.

7. The temperature monitoring device as claimed in claim 6, wherein said device is attached to said machine component using a dispensing apparatus which is adapted to dispense a plurality of said temperature monitoring devices.

8. The temperature monitoring device as claimed in claim 1, wherein said device is integrally formed as part of said machine component.

9. The temperature monitoring device as claimed in claim 1, wherein said machine component is a roller of a conveyor.

10. A dispensing apparatus adapted to house a plurality of the temperature monitoring devices as claimed in claim 1, the apparatus including a tube with an end cap, the end cap, wherein the tube is adapted to house a plurality of disc-shaped devices, the end cap having an opening partially obscured by a flange, whereby, each device may be removed from the dispensing apparatus in a lateral direction relative to a longitudinal axis of the tube.

11. A dispenser including:
a tube adapted to house a plurality of devices;
biasing means associated with said tube adapted to bias any devices within said tube towards a dispensing end of said tube; and,
the dispensing end including an opening with a flange partially surrounding said opening;
such that in use, when the dispenser is moved in a lateral direction, one of said devices housed within said tube is dispensed from said tube.

12. A dispenser as claimed in claim 11, adapted to dispense a device as claimed in claim 1.
